(19) United States
(12) Patent Application Publication
(10) Pub. No.: US 2012/0252939 A1
(43) Pub. Date: Oct. 4, 2012

(54) ASPHALTIC COMPOSITIONS, FILLED ASPHALTIC MATERIALS, AND METHODS FOR MAKING ASPHALTIC COMPOSITIONS

(75) Inventors: Scott Hacker, River Edge, NJ (US); Yonghong Ruan, Wayne, NJ (US); Ho-Nan Sung, Livingston, NJ (US); Richard Heath, Morristown, NJ (US)

(73) Assignee: HONEYWELL INTERNATIONAL INC., Morristown, NJ (US)

(21) Appl. No.: 13/434,711

(22) Filed: Mar. 29, 2012

Related U.S. Application Data
(60) Provisional application No. 61/471,482, filed on Apr. 4, 2011.

(51) Int. Cl. C08L 95/00

(52) U.S. Cl. 524/69

(57) ABSTRACT

An asphaltic composition comprises base asphalt and a low molecular weight ethylene vinyl acetate copolymer. The low molecular weight ethylene vinyl acetate copolymer is present in an amount of from about 0.1 to about 5 wt. % of the base asphalt.

### CROSS-REFERENCE TO RELATED APPLICATIONS

This application is related to and claims all available benefit of U.S. Provisional Patent Application 61/471,482 filed Apr. 4, 2011, the entire contents of which are herein incorporated by reference.

### FIELD OF THE INVENTION

The present invention relates generally to asphaltic compositions, filled asphaltic materials, and methods for making asphaltic compositions, and more particularly relates to asphaltic compositions having low temperature performance for paving and/or roofing applications, filled asphaltic materials containing such asphaltic compositions, and methods for making such asphaltic compositions.

### BACKGROUND OF THE INVENTION

Materials containing asphalt or asphaltic materials are commonly used in paving and roofing applications. For paving applications, asphalt is mixed with aggregate to form a paving material that is used to yield asphalt pavement for road construction and maintenance. For roofing applications, asphalt may be applied directly to a roof structure where aggregate is spread over and pressed into the asphalt to form a built up roof, or coated onto fiberglass, polyester or other mat to form a membrane or shingle. Inorganic filler such as a mineral filler may be mixed into the asphalt for roofing applications.

The strength and durability of asphalt materials depend on various factors including the properties of the materials used and the environmental conditions to which the asphalt material is exposed. Conventional asphalt materials suffer from various types of distress modes due to exposure to environmental conditions, such as, for example, permanent deformation and creep at high temperatures and brittleness and cracking at low temperatures. To improve resistance of asphalt materials to these various distress modes, high temperature performance additives, e.g., plastomers and/or elastomers, and/or low temperature performance additives, e.g., process oils, are incorporated into the asphalt materials. The high temperature performance additives tend to increase the modulus of the asphalt material at higher temperatures to resist permanent deformation and creep while the low temperature performance additives tend to increase flexibility and ductility of the asphalt material at lower temperatures to resist brittleness and cracking. Unfortunately, current low temperature performance additives are not always as effective as desired at increasing the flexibility and ductility of the asphalt material at lower temperatures, and often detract from the high temperature performance properties of the asphalt material even with the addition of high temperature performance additives.

Accordingly, it is desirable to provide asphalt materials with improved low temperature performance. Moreover, it is desirable to provide asphalt materials with both improved low temperature performance and high temperature performance. Furthermore, other desirable features and characteristics of the present invention will become apparent from the subsequent detailed description of the invention and the appended claims, taken in conjunction with the accompanying drawings and this background of the invention.

### SUMMARY OF THE INVENTION

Asphaltic compositions, filled asphaltic materials containing asphaltic compositions, and methods for making asphaltic compositions are provided herein. In accordance with an exemplary embodiment, an asphaltic composition comprises base asphalt and a low molecular weight ethylene vinyl acetate copolymer. The low molecular weight ethylene vinyl acetate copolymer is present in an amount of from about 0.1 to about 5 wt. % of the base asphalt.

In accordance with another exemplary embodiment, a filled asphaltic material is provided. The filled asphaltic material comprises an asphaltic composition present in an amount of about 3 to about 99 wt. % of the filled asphaltic material. The asphaltic composition comprises base asphalt and a low molecular weight ethylene vinyl acetate copolymer that is present in an amount of from about 0.1 to about 5 wt. % of the base asphalt. An inorganic filler is present in an amount of from about 1 to about 97 wt. % of the filled asphaltic material.

In accordance with another exemplary embodiment, a method for making an asphaltic composition is provided. The method comprises the step of combining a low molecular weight ethylene vinyl acetate copolymer and base asphalt at an elevated temperature to form the asphaltic composition. The low molecular weight ethylene vinyl acetate copolymer is present in an amount of from about 0.1 to about 5 wt. % of the base asphalt.

### DETAILED DESCRIPTION

The following Detailed Description is merely exemplary in nature and is not intended to limit the invention or the application and uses of the invention. Furthermore, there is no intention to be bound by any theory presented in the preceding Background of the Invention or the following Detailed Description.

The various embodiments contemplated herein relate to asphaltic compositions having low temperature performance for paving and/or roofing applications, filled asphaltic materials containing such asphaltic compositions, and methods for making such asphaltic compositions. In an exemplary embodiment, the asphaltic composition comprises base asphalt and a minor amount of low molecular weight ethylene vinyl acetate copolymer. The inventors have found that the low molecular weight ethylene vinyl acetate copolymer increases flexibility and ductility of the asphaltic composition at lower temperatures, thereby improving the low temperature performance of the asphaltic composition. In addition, the inventors have also found that the high temperature performance of the asphaltic composition is preferably not compromised by the presence of the low molecular weight ethylene vinyl acetate copolymer even if the asphaltic composition contains high temperature performance additives such as plastomers and/or elastomers.

In an exemplary embodiment, the low molecular weight ethylene vinyl acetate copolymer is present in the asphaltic composition in an amount of from about 0.1 to about 5 weight percent (wt. %) of the base asphalt. It is preferred that the low molecular weight ethylene vinyl acetate copolymer is present in the asphaltic composition in an amount in wt. % of the base asphalt of at least about, with increasing preference in the order given, 0.1, 0.2, 0.3, 0.4, 0.5, 0.6, 0.7, 0.8 and 0.9, and independently, preferably is not more than about, with increasing preference in the order given, 5, 4.5, 4, 3.5, 3, 2.5, 2, 1.5, 1.4, 1.3, 1.2, 1.1 and 1.

Asphalt is defined by the ASTM as a dark brown to black cementitious material in which the predominant constituents are bitumens that occur in nature or are obtained in petroleum processing. Asphalts characteristically contain saturates, aromatics, resins and asphaltenes.

All types of asphalt, naturally occurring, synthetically manufactured and modified, may be used in accordance with the asphaltic materials contemplated herein. Naturally occurring asphalt is inclusive of native rock asphalt, lake asphalt, and the like. Synthetically manufactured asphalt is often a byproduct of petroleum refining operations and includes air-blown asphalt, blended asphalt, cracked or residual asphalt, petroleum asphalt, propane asphalt, straight-run asphalt, thermal asphalt, and the like. Modified asphalt includes base asphalt (e.g., neat or unmodified asphalt that can be naturally occurring or synthetically manufactured) modified with elastomers, phosphoric acid, polyphosphoric acid, plastomers, and the like, or various combinations of these modifiers.

Non-limiting examples of elastomers suitable for modifying the base asphalt such as for high temperature performance include natural or synthetic rubbers including ground tire rubber, butyl rubber, styrene/butadiene rubber (SBR), styrene/ethylene/butadiene/styrene terpolymers (SEBS), polybutadiene, polyisoprene, ethylene/propylene/diene (EPDM) terpolymers, ethylene/n-butyl acrylate/glycidyl methacrylate terpolymers, and styrene/conjugated diene block or random copolymers, such as, for example, styrene/butadiene including styrene/butadiene/styrene copolymer (SBS), styrene/isoprene, and styrene/isoprene-butadiene block copolymer. The block copolymers may be branched or linear and may be a diblock, triblock, tetrablock or multiblock. Non-limiting examples of plastomers suitable for modifying the base asphalt, e.g., for high temperature performance, include polyolefins such as polyethylene, oxidized polyethylene, polypropylene, oxidized polypropylene, and functionalized polyolefins such as maleated polyethylene, maleated polypropylene, ethylene acrylic acid copolymers and the like.

In an exemplary embodiment, the low molecular weight ethylene vinyl acetate copolymer has a vinyl acetate content of from about 1 to about 40 wt. % of the low molecular weight ethylene vinyl acetate copolymer. It is preferred that the low molecular weight ethylene vinyl acetate copolymer has a vinyl acetate content in wt. % of the low molecular weight ethylene vinyl acetate copolymer of at least about, with increasing preference in the order given, 1, 2, 3, 4, 5, and 6, and independently, preferably is not more than about, with increasing preference in the order given, 40, 35, 30, 25, 20, 15, and 13. In another exemplary embodiment, the low molecular weight ethylene vinyl acetate copolymer has a molecular weight of from about 1,000 to about 200,000 Daltons. It is preferred that the low molecular weight ethylene vinyl acetate copolymer has a molecular weight in Daltons of at least about, with increasing preference in the order given, 1,000, 2,000, 3,000, 4,000, 5,000, and 6,000, and independently, preferably is not more than about, with increasing preference in the order given, 200,000, 150,000, 100,000, 75,000, 50,000, 25,000, 20,000, and 15,000. One such suitable ethylene vinyl acetate copolymer is Honeywell® 7117 low molecular weight ethylene vinyl acetate copolymer, manufactured by Honeywell International Inc., which is headquartered in Morristown, N.J.

In an exemplary embodiment, a filled asphaltic material containing the asphaltic composition as discussed in the foregoing paragraphs is provided. The filled asphaltic material comprises the asphaltic composition and inorganic filler. The asphaltic composition and the inorganic filler are present in amounts of from about 3 to about 99 wt. % and from about 1 to about 97 wt. % of the filled asphaltic material, respectively. Depending upon the application that the filled asphaltic material is being used for, the inorganic filler may be mineral filler, aggregate, or a combination of mineral filler and aggregate.

Mineral filler is typically ground stone or mineral, such as, for example, ground limestone or trap rock. Preferably, stone and/or mineral is ground to a particle size of about 180μ or less. “Aggregate” is a collective term for mineral materials, such as, for example, sand, gravel, or crushed stone. The aggregate may comprise natural aggregate, manufactured aggregate, or a combination thereof. Natural aggregate is typically extracted rock from an open excavation (e.g. a quarry) that is reduced to usable sizes by mechanical crushing. Manufactured aggregate is typically a byproduct of other manufacturing processes such as slag from metallurgical processing (e.g. steel, tin, and copper production). Manufactured aggregate also includes specialty materials that are produced to have a particular physical characteristic not found in natural rock, such as, for example, low density.

In an exemplary embodiment, the filled asphaltic material is compounded for a paving application and the inorganic filler is aggregate. The filled asphaltic material comprises the asphaltic composition and the aggregate present in amounts of from about 3 to about 8 wt. % and from about 92 to about 97 wt. % of the filled asphaltic material, respectively. The asphaltic composition comprises base asphalt, the low molecular weight ethylene vinyl acetate copolymer, and a high temperature performance additive, e.g., elastomers, plastomers, or combinations thereof. The low molecular weight ethylene vinyl acetate copolymer and the high temperature performance additive are present in amounts of from about 0.1 to about 5 wt. % and from about 0.5 to about 5 wt. % of the base asphalt, respectively.

In another exemplary embodiment, the filled asphaltic material is compounded for a roofing application and the inorganic filler is mineral filler. The filled asphaltic material comprises the asphaltic composition and the mineral filler present in amounts of from about 30 to about 99 wt. % and from about 1 to about 70 wt. % of the filled asphaltic material, respectively. The asphaltic composition comprises base asphalt, the low molecular weight ethylene vinyl acetate copolymer, and a high temperature performance additive, e.g., elastomers, plastomers, or combinations thereof. The low molecular weight ethylene vinyl acetate copolymer and the high temperature performance additive are present in amounts of from about 0.1 to about 5 wt. % and from about 4 to about 12 wt. % of the base asphalt, respectively.

In an exemplary embodiment for paving applications, the asphaltic composition further comprises a trace amount of crosslinker for crosslinking the asphaltic composition to improve its strength and durability. The crosslinker can be a sulfur or a sulfur derivative, a phenol-aldehyde resin or any other crosslinker or combination of crosslinkers known to those skilled in the art for crosslinking asphalt. In one example, the crosslinker is present in an amount of from about 0.01 to about 0.5 wt. % of the base asphalt.

In an exemplary embodiment, a method for making an asphaltic composition is provided. The method comprises combining the low molecular weight ethylene vinyl acetate copolymer and base asphalt at an elevated temperature to form the asphaltic composition. In one example, the base asphalt and the low molecular weight ethylene vinyl acetate copolymer are combined in a drum-mixer as is well known in the art. In another example, the base asphalt is heated to an elevated temperature of from about 80 to about 190° C. to form a hot liquid asphalt, and the low molecular weight ethylene vinyl acetate copolymer is added to the hot liquid asphalt. Alternatively, the base asphalt and the low molecular weight ethylene vinyl acetate copolymer can be combined and heated to the elevated temperature to form the hot liquid asphalt.

In another exemplary embodiment, the method includes combining a high temperature performance additive and the base asphalt at the elevated temperature. In one example, the high temperature performance additive and the low molecular weight ethylene vinyl acetate copolymer are mixed together to form a blend that is then combined with the base asphalt at the elevated temperature to form the asphaltic composition. The blend can be a physical mixture of the two, a melt blend that can be cooled and shaped into a flake, pellet, briquette or other shape prior to being combined with the base asphalt, or a melt blend that is added directly to the base asphalt. In another example, the high temperature performance additive and the low molecular weight ethylene vinyl acetate copolymer are added separately to the base asphalt at the elevated temperature to form the asphaltic composition. At least a portion of the high temperature performance additive may be added to the based asphalt prior to, concurrently, or subsequently to the addition of the low molecular weight ethylene vinyl acetate copolymer.

The following are examples of asphaltic compositions in accordance with the present invention with each of the components set forth in weight percent. The examples are provided for illustration purposes only and are not meant to limit the various embodiments of the asphaltic compositions in any way.

### Example 1

### PG 70-22 Asphaltic Composition

| Component | Wt. % |
|---|---|
| Base Asphalt (PG 67-22) | 97.5 |
| Low MW Polyethylene | 1.5 |
| Honeywell ® 7117 | 1.0 |
| Total | 100.0 |

### Example 2

### PG 76-22 Asphaltic Composition

| Component | Wt. % |
|---|---|
| Base Asphalt (PG 67-22) | 97.5 |
| Low MW Polyethylene | 2.0 |
| Honeywell ® 7117 | 0.5 |
| Total | 100.0 |

### Example 3

### PG 76-22 Asphaltic Composition

| Component | Wt. % |
|---|---|
| Base Asphalt (PG 67-22) | 97.0 |
| Low MW Polyethylene | 2.5 |
| Honeywell ® 7117 | 0.5 |
| Total | 100.0 |

### Example 4

### PG Modified Asphaltic Composition

| Component | Wt. % |
|---|---|
| Base Asphalt (PG 64-22) | 95.4 |
| SBS | 3.5 |
| Crosslinker | 0.1 |
| Honeywell ® 7117 | 1.0 |
| Total | 100.0 |

Referring to Examples 1-4, various examples of paving grade asphaltic compositions in accordance with exemplary embodiments are provided. The paving grade of an asphaltic composition is described in terms of the performance grade (PG) that is defined by two numbers which represent pavement temperatures. These numbers are determined using the AASHTO M320 standard procedure. The first number PG 64-XX represents the acceptable high pavement temperature in degrees Celsius and the second number PG XX-22 represents the acceptable low pavement temperature in degrees Celsius. The high pavement temperature relates to the effects of permanent deformation and creep at high temperature and the low pavement temperature relates to the effects of brittleness and fatigue cracking at low temperature. The lower the low pavement temperature is of a performance grade (indicated by the second number), the more resistant the asphalt cement is to brittleness and fatigue cracking. For example, an asphaltic composition that has a performance grade of PG 64-22 (e.g. low temperature true grade of −22) is more resistant to brittleness and fatigue cracking than an asphaltic composition that has a performance grade of PG 64-16 (e.g. low temperature true grade of −16).

The asphaltic compositions in Examples 1-4 were prepared using Honeywell® 7117, a low molecular weight ethylene vinyl acetate copolymer, manufactured by Honeywell International Inc., which is headquartered in Morristown, N.J. The asphaltic compositions in Examples 1-3 each contained low molecular weight polyethylene as a high temperature performance additive, and the asphaltic composition in Example 4 contained styrene-butadiene-styrene (SBS) elastomer as the high temperature performance additive. The asphaltic composition in Example 1 met the requirements for a paving grade of PG 70-22; whereas the asphaltic compositions in Examples 2 and 3 met the requirements for a paving grade of PG 76-22. In particular, the asphaltic compositions in Examples 1-3 had actual low temperature true grades of about −23.4 or less providing additional resistance to brittleness and fatigue cracking. The asphaltic composition in Example 4 had excellent ductility at 5° C. indicating good flexibility at low temperatures for roofing applications.

Accordingly, asphaltic compositions having low temperature performance for paving and/or roofing applications, filled asphaltic materials containing such asphaltic compositions, and methods for making such asphaltic compositions have been described. In an exemplary embodiment, the asphaltic composition comprises base asphalt and a minor amount of low molecular weight ethylene vinyl acetate copolymer. The low molecular weight ethylene vinyl acetate copolymer increases flexibility and ductility of the asphaltic composition at lower temperatures, thereby improving the low temperature performance of the asphaltic composition. In addition, the inventors have also found that the high temperature performance of the asphaltic composition is preferably not reduce by the presence of the low molecular weight ethylene vinyl acetate copolymer even if the asphaltic composition contains high temperature performance additives such as plastomers and/or elastomers.

While at least one exemplary embodiment has been presented in the foregoing Detailed Description, it should be appreciated that a vast number of variations exist. It should also be appreciated that the exemplary embodiment or exemplary embodiments are only examples, and are not intended to limit the scope, applicability, or configuration of the invention in any way. Rather, the foregoing Detailed Description will provide those skilled in the art with a convenient road map for implementing an exemplary embodiment of the invention, it being understood that various changes may be made in the function and arrangement of elements described in an exemplary embodiment without departing from the scope of the invention as set forth in the appended Claims and their legal equivalents.

What is claimed is:

1. An asphaltic composition comprising:
base asphalt; and
a low molecular weight ethylene vinyl acetate copolymer present in an amount of from about 0.1 to about 5 wt. % of the base asphalt.

2. The asphaltic composition according to claim 1, wherein the low molecular weight ethylene vinyl acetate copolymer is present in an amount of from about 0.5 to about 2 wt. % of the base asphalt.

3. The asphaltic composition according to claim 1, wherein the low molecular weight ethylene vinyl acetate copolymer has a vinyl acetate content of from about 1 to about 40 wt. % of the low molecular weight ethylene vinyl acetate copolymer.

4. The asphaltic composition according to claim 1, wherein the low molecular weight ethylene vinyl acetate copolymer has a vinyl acetate content of from about 5 to about 15 wt. % of the low molecular weight ethylene vinyl acetate copolymer.

5. The asphaltic composition according to claim 1, wherein the low molecular weight ethylene vinyl acetate copolymer has a molecular weight of from about 1,000 to about 200,000 Daltons.

6. The asphaltic composition according to claim 1, wherein the low molecular weight ethylene vinyl acetate copolymer has a molecular weight of from about 1,000 to about 50,000 Daltons.

7. The asphaltic composition according to claim 1, wherein the low molecular weight ethylene vinyl acetate copolymer has a molecular weight of from about 5,000 to about 20,000 Daltons.

8. The asphaltic composition according to claim 1, further comprising a high temperature performance additive that is present in an amount of from about 0.5 to about 12 wt. % of a base asphalt.

9. The asphaltic composition according to claim 8, wherein the high temperature performance additive comprises an elastomers, a plastomers, or a combination thereof.

10. A filled asphaltic material comprising:
an asphaltic composition present in an amount of about 3 to about 99 wt. % of the filled asphaltic material, the asphaltic composition comprising base asphalt and a low molecular weight ethylene vinyl acetate copolymer that is present in an amount of from about 0.1 to about 5 wt. % of the base asphalt; and
an inorganic filler present in an amount of from about 1 to about 97 wt. % of the filled asphaltic material.

11. The filled asphaltic material according to claim 10, wherein the asphaltic composition is present in an amount of from about 3 to about 8 wt. % of the filled asphaltic material, and the inorganic filler is aggregate that is present in an amount of from about 92 to about 97 wt. % of the filled asphaltic material.

12. The filled asphaltic material according to claim 11, wherein the asphaltic composition further comprises one or more high temperature performance additives that are present in an amount of from about 0.5 to about 5 wt. % of a base asphalt.

13. The filled asphaltic material according to claim 10, wherein the asphaltic composition is present in an amount of from about 30 to about 99 wt. % of the filled asphaltic material, and the inorganic filler is mineral filler that is present in an amount of from about 1 to about 70 wt. % of the filled asphaltic material.

14. The filled asphaltic material according to claim 13, wherein the asphaltic composition further comprises one or more high temperature performance additives that are present in an amount of from about 4 to about 12 wt. % of a base asphalt.

15. A method for making an asphaltic composition, the method comprising the step of combining a low molecular weight ethylene vinyl acetate copolymer and base asphalt at an elevated temperature to form the asphaltic composition, wherein the low molecular weight ethylene vinyl acetate copolymer is present in an amount of from about 0.1 to about 5 wt. % of the base asphalt.

16. The method according to claim 15, further comprising the step of combining a high temperature performance additive and the base asphalt, wherein the high temperature performance additive is present in an amount of from about 0.5 to about 12 wt. % of a base asphalt.

17. The method according to claim 16, wherein the high temperature performance additive and the low molecular weight ethylene vinyl acetate copolymer are combined together to form a low and high end temperature performance blend prior to the steps of combining the low molecular weight ethylene vinyl acetate copolymer and combining the high temperature performance additive, and wherein the steps of combining the low molecular weight ethylene vinyl acetate copolymer and combining the high temperature performance additive both include mixing the low and high end temperature performance blend with the base asphalt.

18. The method according to claim 17, wherein the low and high end temperature performance blend is a physical mixture, a melt blend, or a cooled shaped melt blend.

19. The method according to claim 16, wherein step of combining the high temperature performance additive begins prior to the step of combining the low molecular weight ethylene vinyl acetate copolymer.

20. The method according to claim 16, wherein the step of combining the low molecular weight ethylene vinyl acetate copolymer begins prior to the step of combining a high temperature performance additive.
